(19) United States
(12) Patent Application Publication
(10) Pub. No.: US 2005/0258746 A1
(43) Pub. Date: Nov. 24, 2005

(54) Plasma display panel

(76) Inventors: Jae-Ik Kwon, Suwon-si (KR); Kyoung-Doo Kang, Suwon-si (KR)

Correspondence Address: MCGUIREWOODS, LLP, 1750 TYSONS BLVD, SUITE 1800, MCLEAN, VA, 22102, US

(21) Appl. No.: 11/117,423

(22) Filed: Apr. 29, 2005

(30) Foreign Application Priority Data
May 20, 2004 (KR) 10-2004-0035869

(51) Int. Cl. H01J 17/49

(52) U.S. Cl. 313/582; 313/583

(57) ABSTRACT

A plasma display panel including a first substrate and a second substrate facing each other, barrier ribs disposed between the first substrate and the second substrate and defining a plurality of discharge cells, pairs of first electrodes disposed at side surfaces of the barrier ribs and opposing each other in each discharge cell, pairs of second electrodes disposed at side surfaces of the barrier ribs and opposing each other in each discharge cell and which extend in a direction to intersect the first electrodes, and a dielectric layer covering the first and the second electrodes. The first electrodes and the second electrodes have at least two discharge units in each discharge cell.

### CROSS REFERENCE TO RELATED APPLICATION

This application claims priority to and the benefit of Korean Patent Application No. 10-2004-0035869, filed on May 20, 2004, which is hereby incorporated by reference for all purposes as if fully set forth herein.

### BACKGROUND OF THE INVENTION

1. Field of the Invention

The present invention relates to a plasma display panel (PDP), and more particularly, to a PDP having enhanced light emission efficiency and discharge stability.

2. Discussion of the Background

Recently, flat display apparatuses using a PDP have been increasingly used. Such display apparatuses may be made thin and light weight, and they may have a large screen with excellent image quality and a wide viewing angle. Additionally, PDP display apparatuses can be easily manufactured, and their size can be easily increased, compared to other flat panel displays. Therefore, PDP display apparatuses are being considered as the next-generation large-sized flat display apparatuses.

The PDP may be classified into a direct current (DC) type, an alternating current (AC) type, and a hybrid type depending on applied discharge voltage characteristics, and into an opposing discharge type and a surface-discharge type depending on discharge electrode structures. AC type PDPs having a three-electrode surface-discharge structure are typically utilized.

FIG. 1 shows a conventional AC type three-electrode surface-discharge PDP 100.

The PDP 100 includes the front panel 110 and the rear panel 120. The front panel 110 comprises a front substrate 111, common electrodes 112, which are formed on a lower surface of the front substrate 111, scanning electrodes 113, which form discharge gaps in cooperation with the common electrodes 112, a first dielectric layer 114 covering the common electrodes 112 and the scanning electrodes 113, and a protective layer 115 covering the first dielectric layer 114. The rear panel 120 comprises a rear substrate 121, address electrodes 122, which are disposed on the rear substrate extending in a direction intersecting the common electrodes 112 and the scanning electrodes 113, a second dielectric layer 123 covering the address electrodes 122, barrier ribs 128, which define discharge cells 125, formed on an upper surface of the second dielectric layer 123 and spaced from each other, fluorescent layers 126 formed inside the discharge cells, and discharge gas (not shown), which is filled within the discharge cells 125.

In the conventional three-electrode surface-discharge PDP 100 of FIG. 1, the scanning electrodes 113, the common electrodes 112, the front substrate 111, the first dielectric layer 114, and the protective layer 115 may absorb as much as 40% of otherwise visible rays emitted from the fluorescent layers 126, which decreases light emission efficiency.

Further, an electric field may cause charged particles in the discharge cells 125 to diffuse into the electrodes, as well as into the barrier ribs 128. Since the charged particles that collide with the barrier ribs 128 may not participate in a discharge, priming particles are lost. Consequently, the PDP's light emission efficiency decreases.

### SUMMARY OF THE INVENTION

The present invention provides a PDP having improved light emission efficiency and increased discharge stability.

Additional features of the invention will be set forth in the description which follows, and in part will be apparent from the description, or may be learned by practice of the invention.

The present invention discloses a PDP including a first substrate and a second substrate facing each other, barrier ribs between the first substrate and the second substrate and defining a plurality of discharge cells, a pair of first electrodes on first opposing side surfaces of the barrier ribs in each discharge cell, a pair of second electrodes on second opposing side surfaces of the barrier ribs in each discharge cell, and a dielectric layer covering the first and the second electrodes. The first electrodes and the second electrodes comprise at least two discharge units in each discharge cell.

The present invention also discloses a PDP including a first substrate and a second substrate facing each other, a plurality of discharge cells between the first substrate and the second substrate, a plurality of first electrodes formed between the first substrate and the second substrate and extending in a first direction, and a plurality of second electrodes formed between the first substrate and the second substrate and extending in a second direction that intersects the first direction. A discharge cell comprises two first electrodes and two second electrodes, and each first electrode and each second electrode includes at least two discharge units in the discharge cell.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view showing a conventional PDP.

FIG. 2 is an exploded partially cut away perspective view showing a PDP according to an embodiment of the present invention.

FIG. 3 is a cross-sectional view taken along line III-III of FIG. 2.

FIG. 4 is a schematic diagram showing a discharge cell and electrodes of the PDP of FIG. 2.

FIG. 5 is a cross-sectional view taken along line V-V of FIG. 3 and including adjacent discharge cells.

FIG. 6 is a cross-sectional view taken along line VI-VI of FIG. 3 and including adjacent discharge cells.

FIG. 7 is a diagram schematically illustrating an electrode arrangement according to an embodiment of the present invention.

FIG. 8 is a diagram showing a voltage that may be applied to electrodes of the PDP of FIG. 2 during a sustain discharge.

FIG. 9A, FIG. 9B and FIG. 9C are diagrams showing characteristics of a sustain discharge.

### DETAILED DESCRIPTION OF THE ILLUSTRATED EMBODIMENTS

The present invention will now be described more fully with reference to the accompanying drawings showing exemplary embodiments of the present invention.

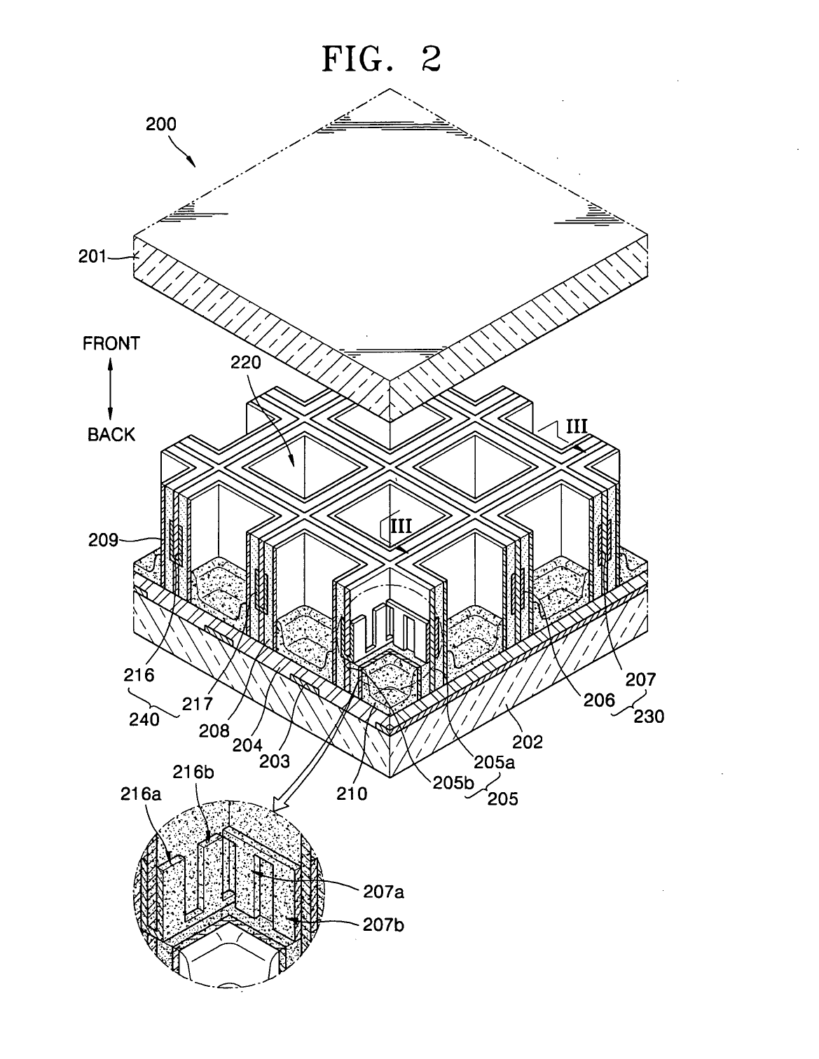

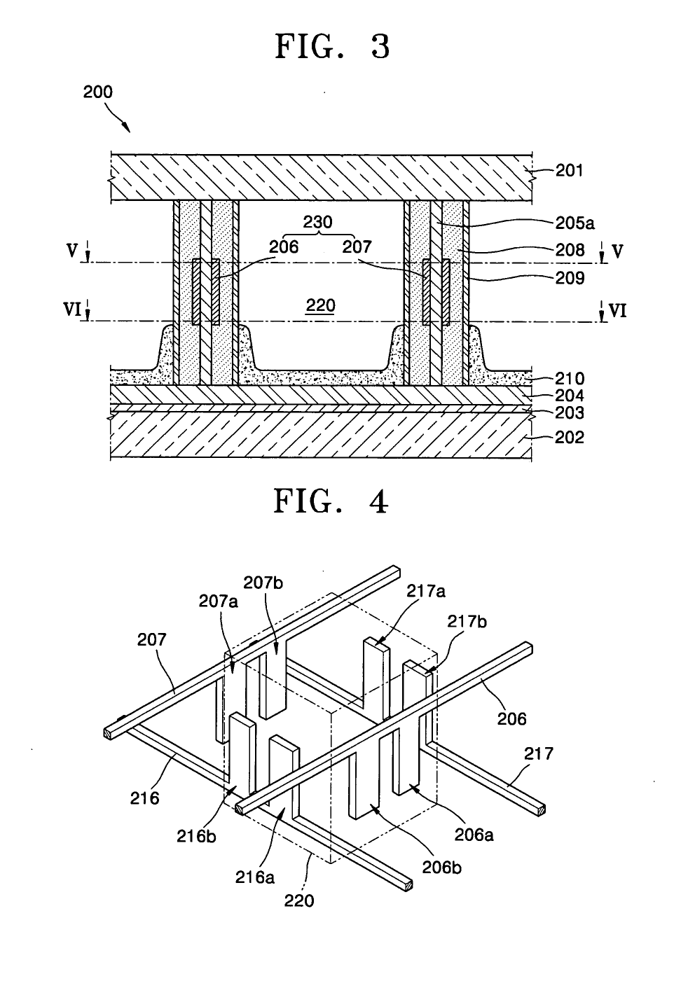

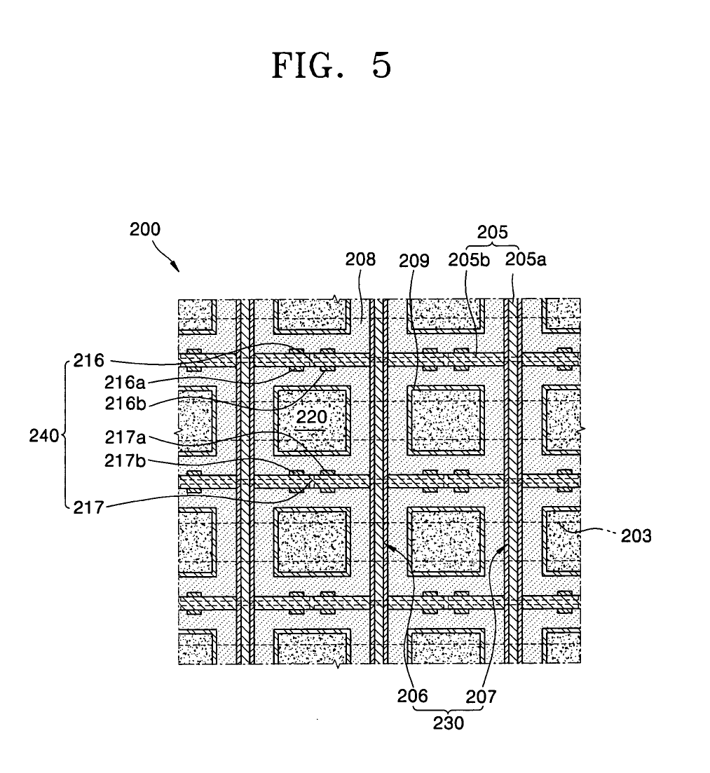

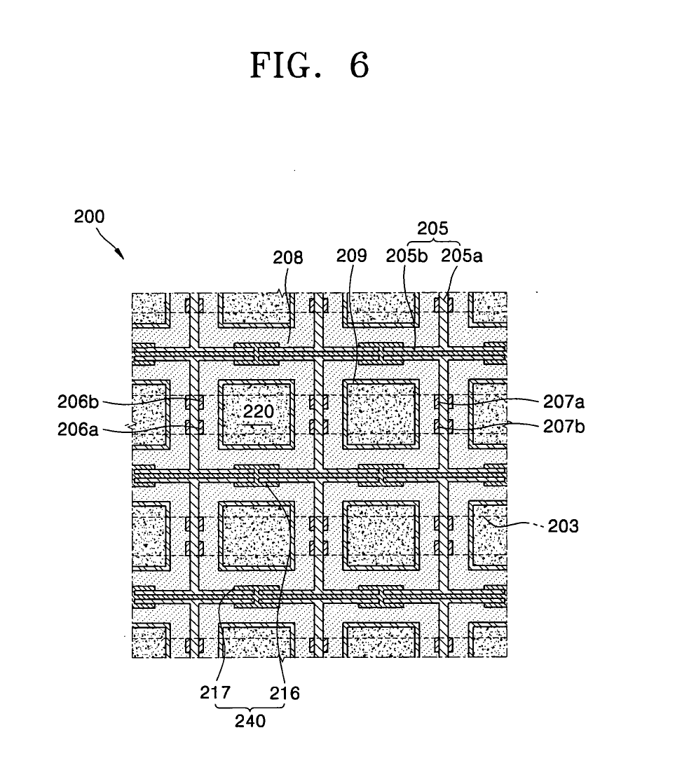

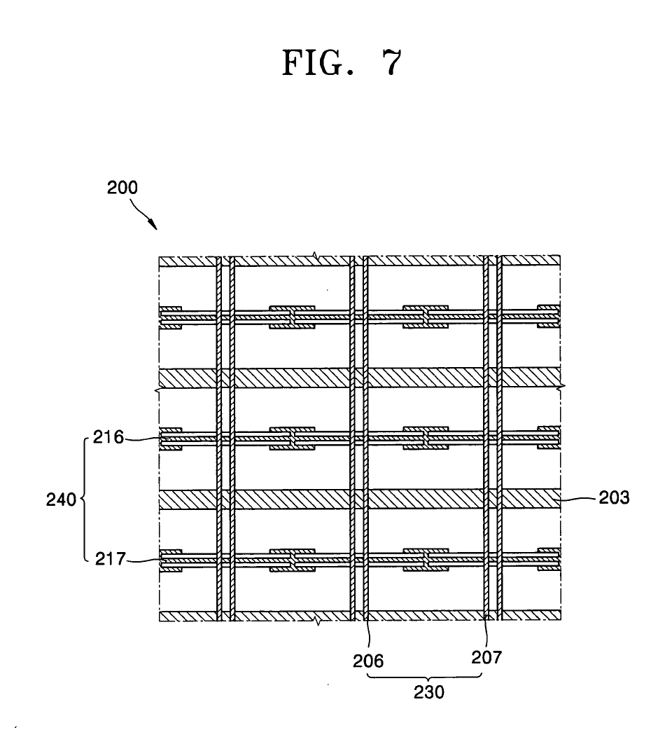

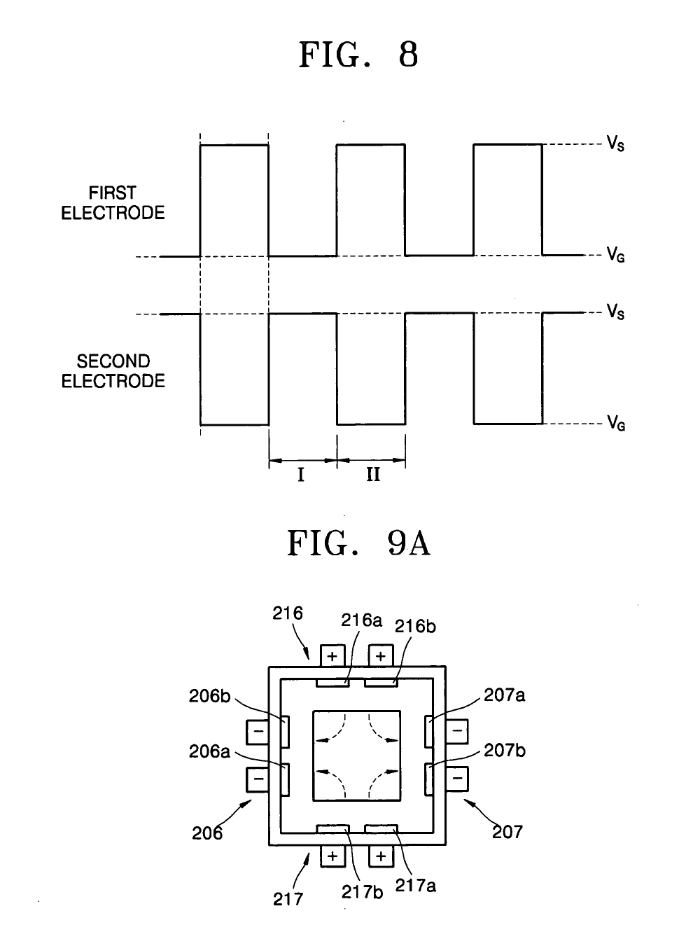

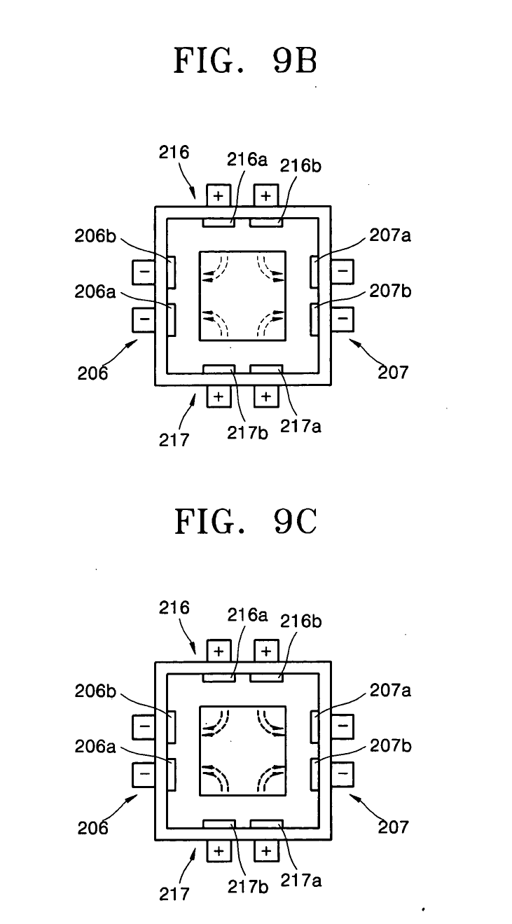

A PDP 200 according to embodiments of the present invention will be described in detail with reference to FIG. 2, FIG. 3, FIG. 4, FIG. 5, FIG. 6, FIG. 7, FIG. 8, FIG. 9A, FIG. 9B, and FIG. 9C.

The PDP 200 may include a first substrate 201 and a second substrate 202 facing each other. Barrier ribs 205, which are disposed between the first substrate 201 and the second substrate 202, define a plurality of discharge cells 220 in cooperation with the first and the second substrates 201, 202. Pairs of first electrodes 230 may be disposed at side surfaces of the barrier ribs 205, and they are formed on opposite sides of the discharge cell 220. Pairs of second electrodes 240 also may be disposed at side surfaces of the barrier ribs 205, they are formed on other opposite sides of the discharge cell 220, and they extend in a direction intersecting the first electrodes 230. A dielectric layer 208 may be formed at side surfaces of the barrier ribs 205 to cover the first and the second electrodes 230, 240, and fluorescent layers 210 may be disposed inside the discharge cells 220.

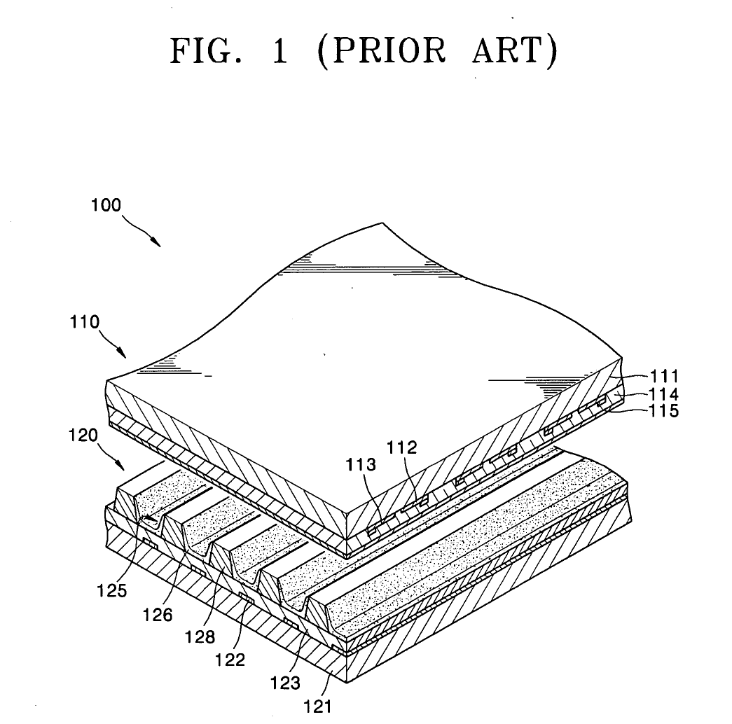

The transparent first substrate 201 may be made of a material such as, for example, glass, which has an excellent light-transmittance. Since the first substrate 201 does not have electrodes 112 and 113, which are formed on a front substrate of a conventional PDP as shown in FIG. 1, the transmittance of the visible rays toward the front of the PDP may be significantly improved. Therefore, when displaying images at the same brightness of a conventional PDP, the sustain electrodes of a PDP according to the present invention can be driven at a relatively lower voltage, thereby improving light emission efficiency.

Generally, the second substrate 202 may also be made of a material such as glass.

The barrier ribs 205 may be formed between the first substrate 201 and the second substrate 202 to define the discharge cells 220 in which a plasma discharge occurs. The barrier ribs 205 may comprise first barrier ribs 205a, which extend in a direction parallel to each other, and second barrier ribs 205b, which extend parallel to each other in a direction intersecting the first barrier ribs 205a. The first barrier ribs 205a and the second barrier ribs 205b may be integrally formed. The matrix-shaped barrier ribs 205 define a plurality of discharge cells 220, where each cell has an independent discharge space.

Although the barrier ribs 205 partition the discharge cells 220 with a tetragonal cross-section in FIG. 2, the present invention is not limited thereto. For example, the barrier ribs 205 may be formed in various shapes, as long as they form a plurality of discharge cells.

A pair of first electrodes 230 and a pair of second electrodes 240 may be disposed at opposite side surfaces of the barrier ribs 205, respectively, in each discharge cell 220. Specifically, a pair of the first electrodes 206, 207 may be disposed on facing side surfaces of the first barrier ribs 205a, respectively, in each discharge cell 220. Further, a pair of the second electrodes 216, 217 may be disposed on facing side surfaces of the second barrier ribs 205b, respectively, in each discharge cell 220.

As FIG. 4, FIG. 5 and FIG. 6 show, the first electrodes 230 and the second electrodes 240 may be spaced apart from each other. For example, as in the present embodiment, the first electrodes 230 may be disposed closer to the first substrate 201 than the second substrate 202, and the second electrodes 240 may be disposed closer to the second substrate 202 than the first substrate 201. However, the positions of the first and the second electrodes 230 and 240 can be exchanged with each other.

FIG. 7 schematically shows an arrangement of the first and second electrodes 230 and 240 in one plane. Here, the first and second electrodes 230 and 240 are vertically spaced apart from each other at points where they intersect.

Additionally, FIG. 4 schematically shows a discharge cell 220 and the first and second electrodes 206, 207, 216, 217. The first electrodes 206, 207 may extend along the side surfaces of the first barrier ribs 205a, and the second electrodes 216, 217 may extend along the side surfaces of the second barrier ribs 205b in a direction intersecting the first electrodes 206, 207. The first and second electrodes 206, 207, 216, 217 may include at least two discharge units inside each discharge cell 220, respectively. In this embodiment, the first and second electrodes 206, 207, 216, 217 comprise two discharge units 206a, 206b, 207a, 207b, 216a, 216b, 217a, 217b, respectively, in each discharge cell 220. The first electrodes 206 and 207 may be symmetrical to each other, and the second electrodes 216 and 217 may be symmetrical to each other. Further, each electrode's discharge units may be separated from each other in the direction that the electrode extends. However, the number and position of the discharge units of the first and second electrodes 206, 207, 216, 217 are not limited to those shown in FIG. 4.

The discharge units 206a, 206b, 207a, 207b, 216a, 216b, 217a, 217b enable wall charge generation in a wide area inside the discharge cells 220, thereby efficiently generating the discharge in the discharge space of each discharge cell 220.

The first electrodes 230 and the second electrodes 240 may be made of a conductive metal such as, for example, aluminium or copper.

The PDP 200 according to an embodiment of the present invention may further include third electrodes 203, which may serve as address electrodes. When the third electrodes 203 are included, the first electrodes 230 may serve as scanning electrodes and the second electrodes 240 may serve as common electrodes.

Since the second electrodes 240 may serve as common electrodes, second electrodes 240 of adjacent discharge cells 220 may be connected to each other through the second barrier ribs 205b, as shown in FIG. 2 and FIG. 6. More specifically, a second electrode 216 of a discharge cell 220 may be connected to a second electrode 217 of an adjacent discharge cell 220 through a shared second barrier rib 205b. Therefore, a common sustain voltage may be applied to the second electrodes 240, which generate a sustain discharge in cooperation with the first electrodes 230.

When the third electrodes 203 are not provided, the first electrodes 230 may serve as the scanning and sustain electrodes, and the second electrodes 240 may serve as the address and sustain electrodes.

A dielectric layer 208 may be formed on the barrier ribs 205 to cover the first and second electrodes 230 and 240. Specifically, the dielectric layer 208 may be coated on the side surfaces of the first barrier ribs 205a to cover the first electrodes 230. Further, the dielectric layer 208 may be coated on the side surfaces of the second barrier ribs 205b to cover the second electrodes 240. The dielectric layer 208 may be locally formed such that it covers those portions of the barrier rib where the first and the second electrodes 230 and 240 are formed. Alternatively, as FIG. 2 shows, the dielectric layer 208 may cover the entire side surfaces of the barrier ribs 205 in each discharge cell 220.

During discharging, the dielectric layer 208 prevents the first electrodes 230 and the second electrodes 240 from being electrically connected to each other, protects the electrodes 230 and 240 from damage due to collision with charged particles, and stores wall charges by inducing charged particles. The dielectric layer 208 may be made of a dielectric substance such as, for example, PbO, B₂O₃, or SiO_{2.}

A protective layer 209, which may be made of, for example, magnesium oxide (MgO), may be included to cover the dielectric layer 208. The protective layer 209 protects the dielectric layer 208 from damage by collision with charged particles, and it emits secondary electrons during discharging.

The third electrodes 203 may be formed between the second substrate 202 and the fluorescent layers 210, and they may extend in a direction intersecting the discharge cells 220. Specifically, the third electrodes 203 may extend parallel to the second electrodes 240 and pass between the second barrier ribs 205b.

Alternatively, the third electrodes 203 may be formed extending in a direction intersecting the second electrodes 240. In other words, the third electrodes 203 may be formed extending in a direction that is parallel to the direction that the first electrodes 230 extend. In this case, the third electrodes 203 would pass between the first barrier ribs 205a.

A lower dielectric layer 204, which may cover the third electrodes 203, may be made of a dielectric substance that can prevent cations or electrons from colliding with, and damaging, the third electrodes 203 and that can induce electric charges during discharging. The dielectric substance may include, for example, PbO, B₂O₃, or SiO_{2.}

As FIG. 2 and FIG. 3 show, fluorescent layers 210 may be formed on the lower side surfaces of the discharge cells 220 and on the dielectric layer 204. The fluorescent layers 210 receive ultraviolet rays and emit visible rays. The fluorescent layers formed in red sub-pixels may include a fluorescent substance such as, for example, Y(V, P)O₄:Eu, the fluorescent layers formed in green sub-pixels may include a fluorescent substance such as, for example, Zn₂SiO₄:Mn, or YBO₃:Tb, and the fluorescent layers formed in blue sub-pixels may include a fluorescent substance such as, for example, BAM:Eu.

A discharge gas such as, for example, Ne or Xe, or a mixture thereof, may be filled and sealed in the discharge cells 220. According to embodiments of the present invention, the amount of generated plasma may increase and low-voltage driving may be possible because the discharge area can be increased and the discharge space can be enlarged. Therefore, even if the discharge gas includes highly-concentrated Xe gas, low-voltage driving, which was difficult to perform conventionally, may be possible, thereby significantly increasing the PDP's light emission efficiency.

In the PDP 200 described above, applying an address voltage between a third electrode 203 and the first electrodes 230 of a discharge cell 220 generates an address discharge, thereby selecting the discharge cell 220.

Next, applying a sustain discharge voltage between the first electrodes 230 and the second electrodes 240 of the selected discharge cell 220 generates a sustain discharge between the first and second electrodes 230 and 240. The sustain discharge excites the discharge gas, which emits ultraviolet rays while its energy level decreases. The ultraviolet rays excite the fluorescent layers 210 coated inside the discharge cells 220, and the fluorescent layers 210 emit visible rays while their energy level decreases, thereby displaying an image.

Characteristics of a sustain discharge occurring in the discharge cells 220 during sustain discharging will now be described.

Each discharge cell 220 may comprise a pair of first electrodes 206 and 207 and a pair of second electrodes 216 and 217. A voltage having the same wave form may be applied to the first electrodes 206 and 207, and a voltage having the same wave form may be applied to the second electrodes 216 and 217.

FIG. 8 shows sustain discharge pulses, which may be applied to the first and second electrodes 206, 207, 216, and 217, respectively, of the PDP 200 according to an embodiment of the present invention. FIG. 9A, FIG. 9B and FIG. 9C are diagrams showing characteristics of a sustain discharge resulting from applying the waveforms of section “I” of FIG. 8.

Referring to section “I” of FIG. 8, a sustain voltage V_{S} may be applied to the second electrodes 216 and 217, and a ground voltage V_{G}, which is relatively lower than the sustain voltage V_{S}, may be applied to the first electrodes 206 and 207. At this time, as shown in FIG. 9A, the second electrodes 216 and 217 become plus (+) electrodes, the first electrodes 206 and 207 become minus electrodes (−), and an electric field is generated in the discharge cells 220 that were previously selected by address discharge. Therefore, discharge units of each electrode have a voltage of the corresponding electrode, whereby discharge units 206a and 206b of the first electrodes become minus electrodes, and discharge units 217a and 217b of the second electrodes become plus electrodes.

At this time, if a voltage applied between the first electrodes 206, 207 and the second electrodes 216, 217, together with the discharge cell's wall charges, exceeds a discharge firing voltage, as shown in FIG. 9A, the sustain discharge may begin at corners of the discharge cell 220, where the distance between electrodes is short. For example, a discharge unit 206b of the first electrodes discharges mainly with a discharge unit 216a of the adjacent second electrode, and a discharge unit 206a discharges mainly with a discharge unit 217b of the adjacent second electrode. Accordingly, each discharge unit may discharge with the discharge unit of the adjacent other electrode, so that all discharge units 206a, 206b, 207a, 207b, 216a, 216b, 217a, 217b can stably participate in the sustain discharge.

Specifically, when the discharge first occurs between a pair of electrodes (for example, between one first electrode 206 and one second electrode 216, or between the other first electrode 207 and the other second electrode 217) of the discharge cell 220, because wall charges may be intensively stored at only electrodes in which the discharge first occurs, the discharge may irregularly occur at the discharge cell. However, because the wall charges are distributed in the PDP of the present invention, even if the discharge first occurs between some electrodes, the wall charges may remain at electrodes in which the discharge does not initially occur, which may allow the discharge to eventually occur at the electrodes, thereby improving discharge stability.

As shown in FIG. 9B and FIG. 9C, after the discharge occurs, a discharge voltage between electrodes gradually decreases. However, if an external, high voltage is continuously applied, the discharge may spread to areas where a longer distance exists between electrodes. When the voltage difference between two electrodes 230, 240 becomes less than a discharge firing voltage, the discharge stops, and space charges and wall charges are generated inside the discharge cell 220.

Thereafter, at a pulse section (section “II” of FIG. 8) where the polarity of the first electrodes 206, 207 and the second electrodes 216, 217 changes, the discharge occurs again.

In the PDP 200 according to embodiments of the present invention, since the electrodes 206 and 207 are disposed at the side surfaces of the barrier ribs 205 and the discharge occurs in the electrodes 206 and 207 as a whole, the number of priming particles not participating in the discharge may decrease.

Specifically, the sustain discharge according to the present invention may begin at four corners of the discharge cell 220 and gradually spread into the discharge cell's center. Therefore, the volume of space in which the sustain discharge occurs may increase. Further, the space charges in the discharge cells 200, which might not have been used in the conventional PDP, can contribute to light emission. Consequently, the PDP's discharge efficiency may increase.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a first substrate and a second substrate facing each other;
barrier ribs between the first substrate and the second substrate and defining a plurality of discharge cells;
a pair of first electrodes on first opposing side surfaces of the barrier ribs in each discharge cell;
a pair of second electrodes on second opposing side surfaces of the barrier ribs in each discharge cell; and
a dielectric layer covering the first electrodes and the second electrodes,
wherein the first electrodes and the second electrodes have at least two discharge units in each discharge cell.

2. The PDP of claim 1, wherein the first electrodes have the same number of discharge units in each discharge cell.

3. The PDP of claim 2, wherein the first electrodes have 2 discharge units in each discharge cell.

4. The PDP of claim 1, wherein the second electrodes have the same number of discharge units in each discharge cell.

5. The PDP of claim 4, wherein the second electrodes have 2 discharge units in each discharge cell.

6. The PDP of claim 1, wherein the discharge units of the first electrodes are symmetrical to each other and the discharge units of the second electrodes are symmetrical to each other.

7. The PDP of claim 1, wherein the first electrodes extend in a first direction along sides of the barrier ribs.

8. The PDP of claim 7, wherein the discharge units of the first electrodes are separated from each other in the first direction.

9. The PDP of claim 1, wherein the second electrodes extend in a second direction along sides of the barrier ribs.

10. The PDP of claim 9, wherein the discharge units of the second electrodes are separated from each other in the second direction.

11. The PDP of claim 1, further comprising third electrodes extending across the discharge cells.

12. The PDP of claim 11, further comprising a fluorescent layer in a the discharge cells,
wherein the third electrodes are arranged between the fluorescent layer and the second substrate.

13. The PDP of claim 11, wherein the third electrodes extend in a direction that intersects a direction in which the first electrodes or the second electrodes extend.

14. The PDP of claim 11, further comprising a lower dielectric layer covering the third electrodes.

15. The PDP of claim 1, further comprising a protective layer covering the dielectric layer.

16. The PDP of claim 1, wherein the barrier ribs are formed in a matrix shape.

17. The PDP of claim 1, wherein a second electrode of a first discharge cell is connected to a second electrode of a second discharge cell, and
wherein the first discharge cell and the second discharge cell are adjacent to each other along a direction that is substantially perpendicular to a direction along which the second electrodes extend.

18. The PDP of claim 1, wherein the first electrodes and the second electrodes are arranged apart from each other.

19. A plasma display panel (PDP), comprising:
a first substrate and a second substrate facing each other;
a plurality of discharge cells between the first substrate and the second substrate;
a plurality of first electrodes formed between the first substrate and the second substrate and extending in a first direction; and
a plurality of second electrodes formed between the first substrate and the second substrate and extending in a second direction that intersects the first direction,
wherein a the discharge cells comprises two first electrodes and two second electrodes, each first electrode and each second electrode including at least two discharge units.

20. The PDP of claim 19, wherein the two first electrodes face each other in the discharge cell and the two second electrodes face each other in the discharge cell.
